(19) United States
(12) Patent Application Publication
(10) Pub. No.: US 2015/0199665 A1
(43) Pub. Date: Jul. 16, 2015

(54) Method of Payment for Wireless Charging Service

(71) Applicant: HTC Corporation, Taoyuan County (TW)

(72) Inventor: Feng-Seng Chu, Taoyuan City (TW)

(21) Appl. No.: 14/592,915

(22) Filed: Jan. 9, 2015

Related U.S. Application Data
(60) Provisional application No. 61/925,665, filed on Jan. 10, 2014.
(60) Provisional application No. 61/979,010, filed on Apr. 14, 2014.

(51) Int. Cl. G06Q 20/14; G06Q 20/32; H02J 7/02

(52) U.S. Cl. CPC G06Q 20/145; H02J 7/025; G06Q 20/3278; G06Q 20/322

(57) ABSTRACT

A method of payment for wireless charging service for a mobile device includes detecting wireless power supplied by a power base station, sending a first message to the power base station to initiate an electronic payment (e-payment) procedure if the wireless power supplied by the power base station is detected, receiving a second message from the power base station to indicate that the power base station is ready for the e-payment procedure, performing the e-payment procedure with the power base station; and receiving the wireless power from the power base station if the e-payment procedure is succeeded, or not receiving the wireless power from the power base station if the e-payment procedure is failed.

### CROSS REFERENCE TO RELATED APPLICATIONS

This application claims the benefit of U.S. Provisional Application No. 61/925,665, filed on Jan. 10th, 2014 and entitled “Method and Apparatus of authentication and payment for wireless charging”, and U.S. Provisional Application No. 61/979,010, filed on Apr. 14th, 2014 and entitled “Method and Apparatus of authentication and payment for wireless charging”, the contents of which are incorporated herein in their entirety.

### BACKGROUND OF THE INVENTION

1. Field of the Invention

The present invention relates to a method of payment for wireless charging service, and more particularly, to a method of payment for wireless charging service realized by electronic payment.

2. Description of the Prior Art

With the proliferation of portable electronic devices such as mobile device (MD), smart phone and tablet PC, the demand for charging devices, especially for those provided in public areas, is increasing. In addition, people would like to get rid of annoying wires if possible. One technology which realizes this desire is wireless charging, in which portable electronic device (s) comprising a power receiver is placed on and charged through a wireless charging device (e.g. a power base station comprising a power transmitter). Therefore, the current trend aims at providing wireless charging in public areas such as coffee shops, stores, train stations, airports, and restaurants, so that people can easily find a wireless power supply to charge their portable electronic devices.

Wireless Power Consortium (WPC) is a leading organization in the world to define wireless charging specifications. The document “Wireless Power Transfer—Volume I, part I” and the document “Wireless Power Transfer—Volume 2, part I” define the interaction between a power base station (or a power transmitter) and a mobile device (or a power receiver).

However, all the existing protocols are used for power charging and there is no consideration for other applications. Wireless power provider cannot bill their customer for power charging, since there is no payment in the protocol.

Therefore, there is a need to implement payment mechanism for wireless charging in order to meet the business requirement of deploying wireless charging services in public areas.

### SUMMARY OF THE INVENTION

An objective of the present invention is to provide a method of payment for wireless charging service realized by electronic payment (e-payment).

The present invention discloses a method of payment for wireless charging service for a mobile device. The method includes detecting wireless power supplied by a power base station; sending a first message to the power base station to initiate an electronic payment (e-payment) procedure if the wireless power supplied by the power base station is detected, receiving a second message from the power base station to indicate that the power base station is ready for the e-payment procedure, performing the e-payment procedure with the power base station, and receiving the wireless power from the power base station if the e-payment procedure is succeeded, or not receiving the wireless power from the power base station if the e-payment procedure is failed.

The present invention further discloses a method of payment for wireless charging service for a mobile device. The method includes detecting wireless power supplied by a power base station, receiving a first message from the power base station to initiate an electronic payment (e-payment) procedure if the wireless power supplied by the power base station is detected, sending a fourth message to the power base station to perform the e-payment procedure initiated by the power base station, performing the e-payment procedure with the power base station, and receiving wireless power from the power base station if the e-payment procedure is succeeded, or not receiving the wireless power from the power base station if the e-payment procedure is failed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a wireless charging system according to an example of the present disclosure.

FIG. 2 is a functional block diagram of a wireless charging system 20 according to an example of the present invention.

FIG. 3 illustrates a schematic diagram of a wireless charging system 30 in accordance with an example of the present invention.

FIG. 4 is a flowchart of a process according to an example of the present invention.

FIG. 5 illustrates a signal diagram corresponding to the process shown in FIG. 4.

FIG. 6 illustrates a signal diagram of payment for wireless charging service when the e-payment procedure is realized over communication technologies which generate interference to the wireless power according to an example of the present invention.

FIG. 7 is a flowchart of a process according to an example of the present invention.

FIG. 8 illustrates a signal diagram corresponding to the process shown in FIG. 7.

FIG. 9 illustrates a signal diagram of payment for wireless charging service when the e-payment procedure is realized over communication technologies which generate interference to the wireless power according to an example of the present invention.

FIG. 10 to FIG. 13 illustrate signal diagrams when the e-payment procedure is failed according to various examples of the present invention.

### DETAILED DESCRIPTION

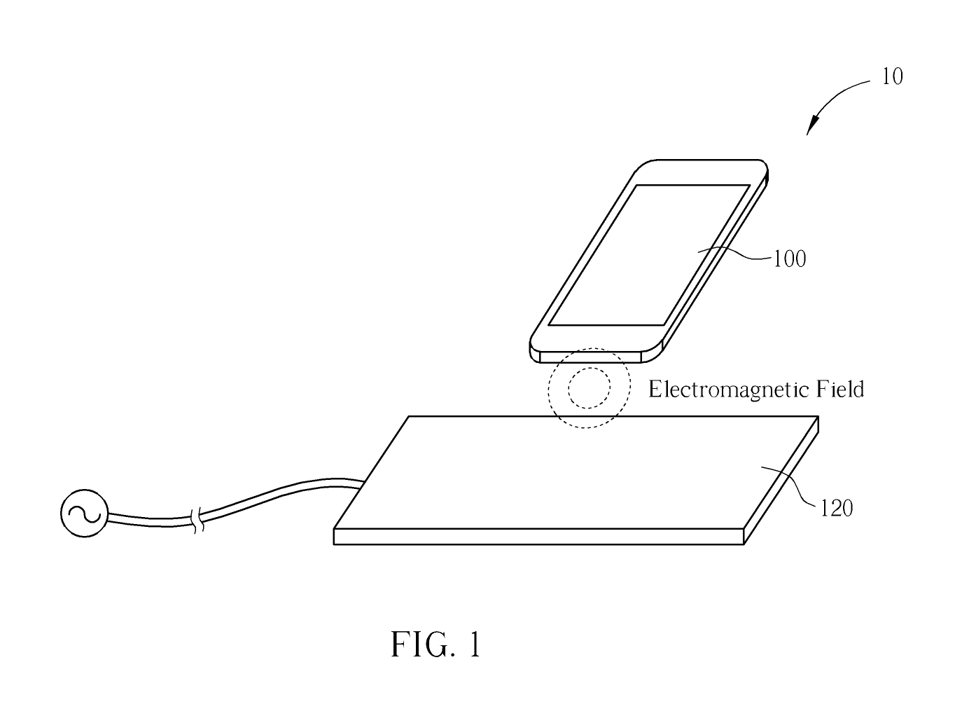

Please refer to FIG. 1, which illustrates a schematic diagram of a wireless charging system 10 according to an example of the present disclosure. A wireless charging system may include at least one wireless charging device and at least one mobile device that can be charged by the wireless charging device. For simplicity, in FIG. 1, the wireless charging system 10 is briefly composed of a mobile device 100 and a wireless charging device 120. The wireless charging device 120 may represent a power base station (PBS), including a power transmitter or a power transmitting module with digital/analog chip (s), to supply wireless power to the mobile device 100. The mobile device 100 may be any portable electronic device such as a mobile device (MD), a mobile phone, a laptop, a tablet computer, an electronic book, a portable computer system, or at least a power receiver or a power receiving module. Alternatively, the mobile device 100 may be any electronic device using battery as its power supply, such as a wearable computing device, a wearable medical device, a portable MP3 player, etc. The mobile device 100 may directly attach to the wireless charging device 120 or keep within a distance from the wireless charging device 120 for wireless charging. As shown in FIG. 1, the mobile device 100 receives wireless power from the wireless charging device 120 by electromagnetic induction so that the battery of the mobile device 100 is charged without using any wire connection.

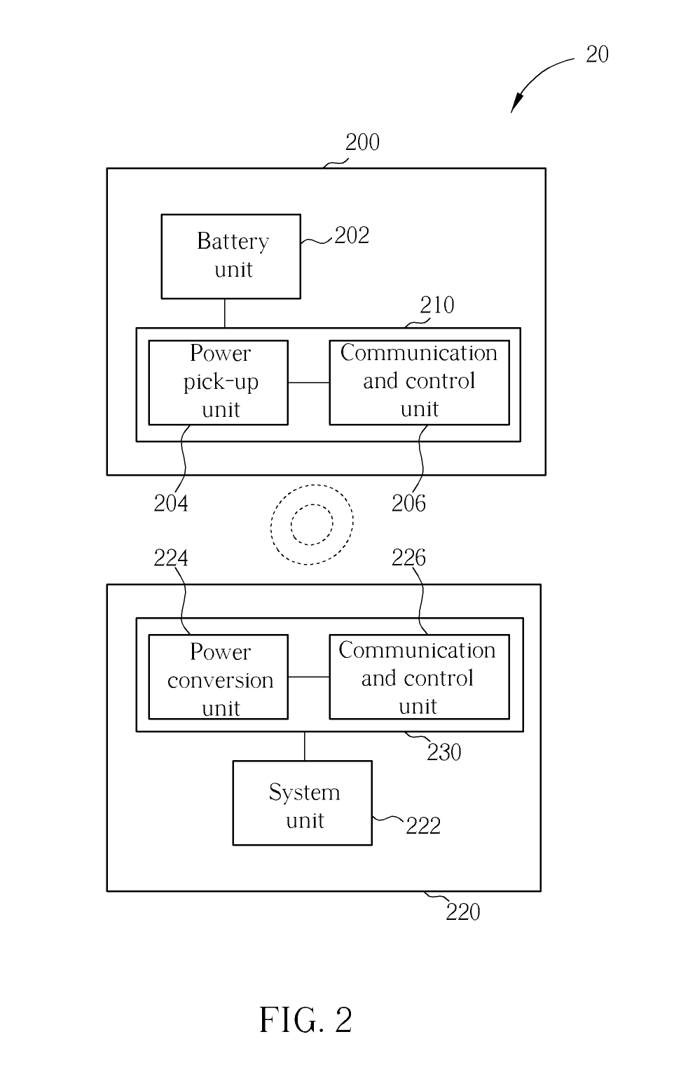

Please refer to FIG. 2, which is a functional block diagram of a wireless charging system 20 according to an example of the present invention. The wireless charging system 20 includes a mobile device 200 and a wireless charging device 220. The mobile device 200 may be the mobile device 100 shown in FIG. 1, and the wireless charging device 220 may be the wireless charging device 120 shown in FIG. 1. The mobile device 200 includes a battery unit 202 and a power receiver 210. The power receiver 210 may include a power pick-up unit 204 used for receiving wireless power to charge the battery unit 202 and a communication and control unit 206 used for communicating, i.e., sending/receiving signals or packets, with the wireless charging device 220 via power signals and controlling the operation of the power pick-up unit 204.

The wireless charging device 220 includes a power transmitter 230 and a system unit 222. The power transmitter 230 may include a power conversion unit 224 used for supplying wireless power and a communication and control unit 226 used for communicating, i.e., sending/receiving signals or packets, with the mobile device 200 and controlling the operation of the power conversion unit 224. The system unit 222 may include a processing means such as a microcontroller, microprocessor or an Application Specific Integrated Circuit (ASIC), for handling wireless charging authentication function activated by a processing result of the power transmitter 230. In the example of FIG. 2, the wireless charging device 220 contains one power transmitter 230. In other examples, the wireless charging device may contain multiple power transmitters for supplying wireless power to multiple portable mobile devices.

The communication and control units 206 and 226 preferably utilize an in-band communication channel for communication, in which communication channels are attached on wireless power signal. In an example, communication from wireless charging device 220 to mobile device 200 may be carried out by using frequency-shift keying (FSK) modulation on the wireless power for transmission. In another example, communication from mobile device 200 to wireless charging device 220 may rely on load modulation (LM). Alternatively, the communication and control units 206 and 226 may be implemented by radio transceivers that transmit and receive radio signals (e.g., messages, emails, or packets) in an out-of-band communication channel (e.g. a short-range communication protocol such as Bluetooth, Bluetooth LE, Wi-Fi).

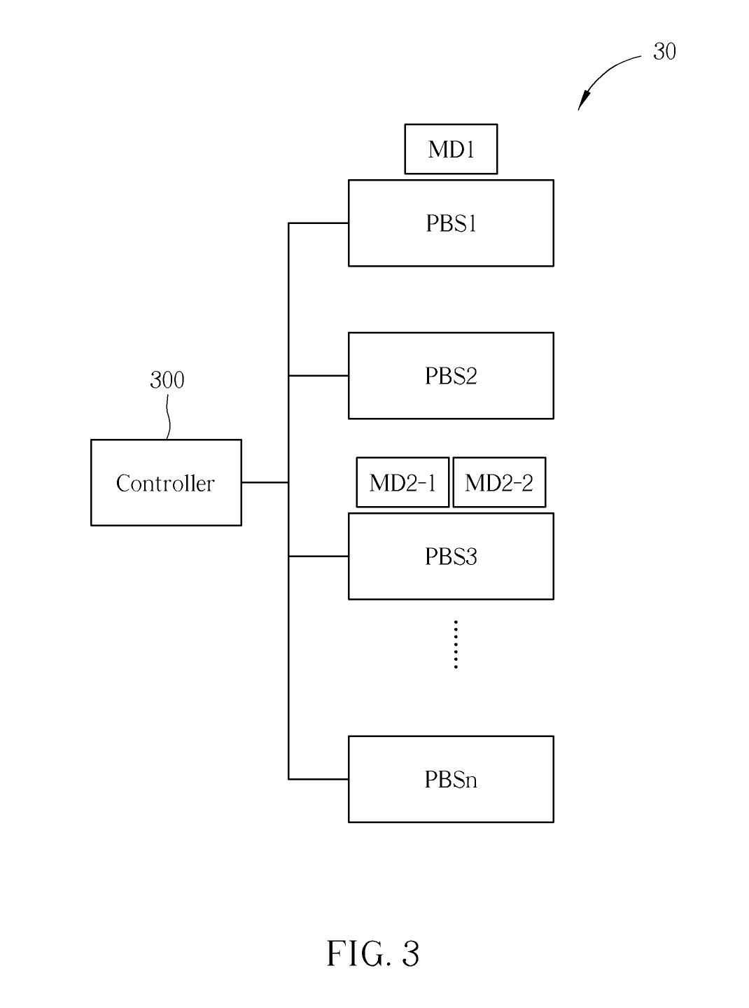

FIG. 3 illustrates a schematic diagram of a wireless charging system 30 in accordance with an example of the present invention. The wireless charging system 30 includes mobile devices MD1, MD2-1, MD2-2, power base stations PBS1-PBSn, and a controller 300 connected to each of the power base stations. The power base stations PBS1-PBSn may be deployed in areas such as coffee shops, stores, train stations, airports, and restaurants for public use. The controller 300 may be a computer or a server at a control center or a front desk of the public area that monitors the usage or performs necessary computation for the power base stations PBS1-PBSn. In addition, if a user of a certain power base station encounters any problem, signals or messages relating to the power base station may be sent to the controller 300 so that people in the control center or the front desk may provide timely assistance. Note that a wireless charging device may be able to charge more than one mobile devices at the same time, as the example of the power base station PBS3 charging the mobile devices MD2-1 and MD2-2 shown in FIG. 3. Therefore, signals or the messages sent to the controller 300 may include necessary information (e.g. an identity of the mobile device) to distinguish the mobile devices MD2-1 and MD2-2 if only one of them encounters problem during wireless charging.

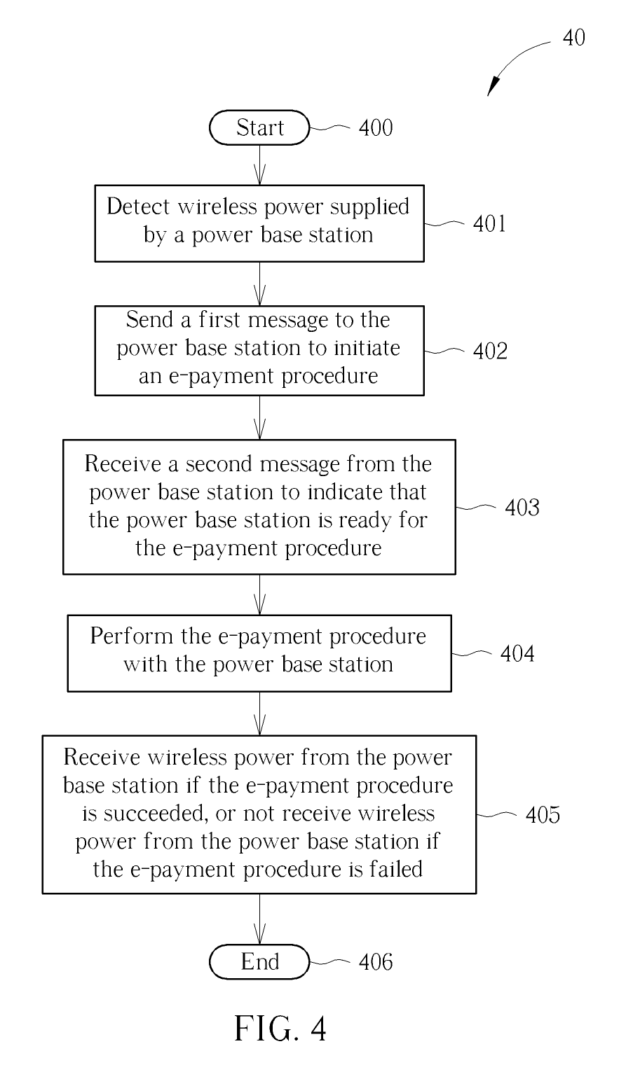

Please refer to FIG. 4, which is a flowchart of a process 40 according to an example of the present invention. The process 40 may be utilized for a mobile device, such as the mobile device MD1, MD2-1 or MD2-2 shown in FIG. 3, to realize payment for wireless charging service in a wireless charging system. A power base station may supply wireless power such that the mobile device is able to detect wireless power to know it is close to the power base station with a power transmitter, and thereby determine whether to initiate an electronic payment (e-payment) procedure for wireless charging. After the mobile device decides to initiate the e-payment procedure, the mobile device may start the process 40 which includes the following steps:

Step 400: Start.

Step 401: Detect wireless power supplied by a power base station.

Step 402: Send a first message to the power base station to initiate an e-payment procedure.

Step 403: Receive a second message from the power base station to indicate that the power base station is ready for the e-payment procedure.

Step 404: Perform the e-payment procedure with the power base station.

Step 405: Receive wireless power from the power base station if the e-payment procedure is succeeded, or not receive wireless power from the power base station if the e-payment procedure is failed.

Step 406: End.

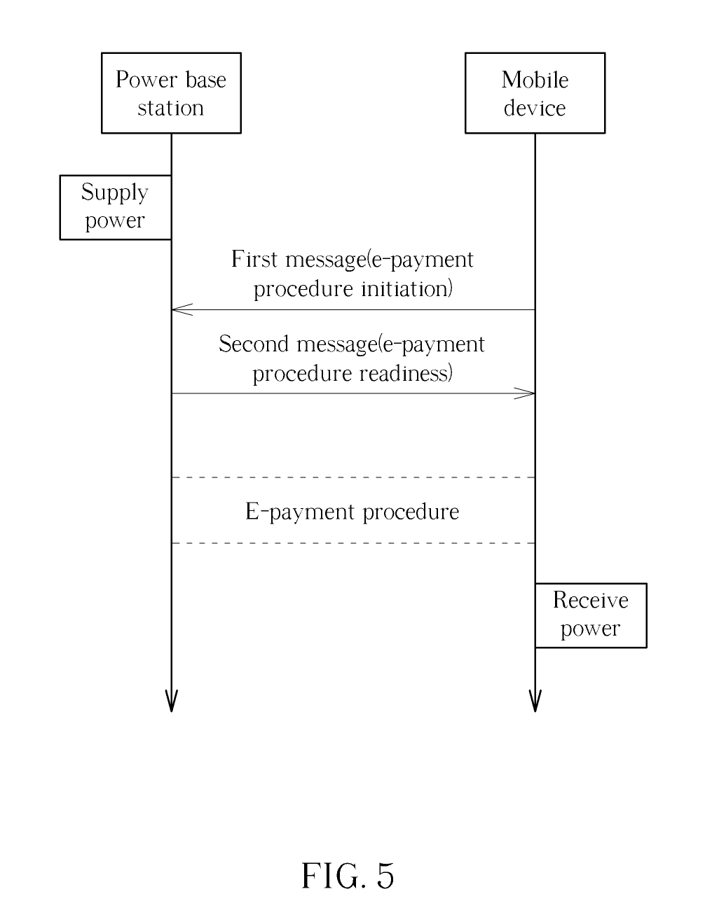

According to the process 40, the mobile device is configured to initiate the e-payment procedure via sending the first message to the power base station if the wireless power supplied by the power base station is detected, receive the second message from the power base station to indicate that the power base station is ready for the e-payment procedure, perform the e-payment procedure with the power base station, and determine whether to receive wireless power from the power base station according to the success or failure of the e-payment procedure. The first and second messages may be sent via bi-directional in-band communication channel. If the e-payment procedure is succeeded, the power base station may supply wireless power to the mobile device. On the contrary, if the e-payment procedure is failed, the power base station may avoid supplying wireless power or release a warning signal. In this manner, the wireless power provider may bill their customers via the e-payment procedure to meet the business requirement of deploying wireless charging services in public areas. The signal diagram of this example is shown in FIG. 5.

Note that the process 40 is an example of the present invention. Those skilled in the art should readily make combinations, modifications and/or alterations on the abovementioned description and examples. For example, when the mobile device discovers the power base station, before the first and second messages are sent and received, the mobile device may send a third message to the power base station to query whether the e-payment procedure is required by the power base station and/or to indicate that the e-payment procedure is supported or configured by the mobile device. Then, the power base station may send a fourth message to the mobile device to indicate payment rule(s) which contains the payment rule(s) of the e-payment procedure. Further, the payment rule may indicate a timing when the e-payment procedure shall be executed, a duration that the e-payment procedure is required, a period of the e-payment procedure, or a timing that the period starts. With the payment rule(s), an owner of the mobile device may decide to pay for the wireless charging service and the mobile device may start the process 40 once the owner agrees with the payment rule(s). This example is applicable to a wireless charging system where there is a communication channel from the power base station to the mobile device.

In order to execute the e-payment procedure, the first message sent by the mobile device and the second message sent by the power base station may contain at least one of the following: an identity of the mobile device, information based on which an amount of money to be charged can be calculated (e.g. price and rate), a timing that the e-payment procedure will start, a duration that the e-payment procedure will last, a period of the e-payment procedure if the e-payment procedure shall be made periodically, an amount of energy that the mobile device received from the beginning of charge or within a specific time period, the timing and period described in the payment rule, and parameters for building up an e-payment connection. In detail, the parameters may be used for communication technologies not attached on wireless power, e.g. Bluetooth, Near Field Communication (NFC), Wi-Fi, Radio-Frequency Identification (RFID) and communication standards released by 3rd Generation Partnership Project (3GPP).

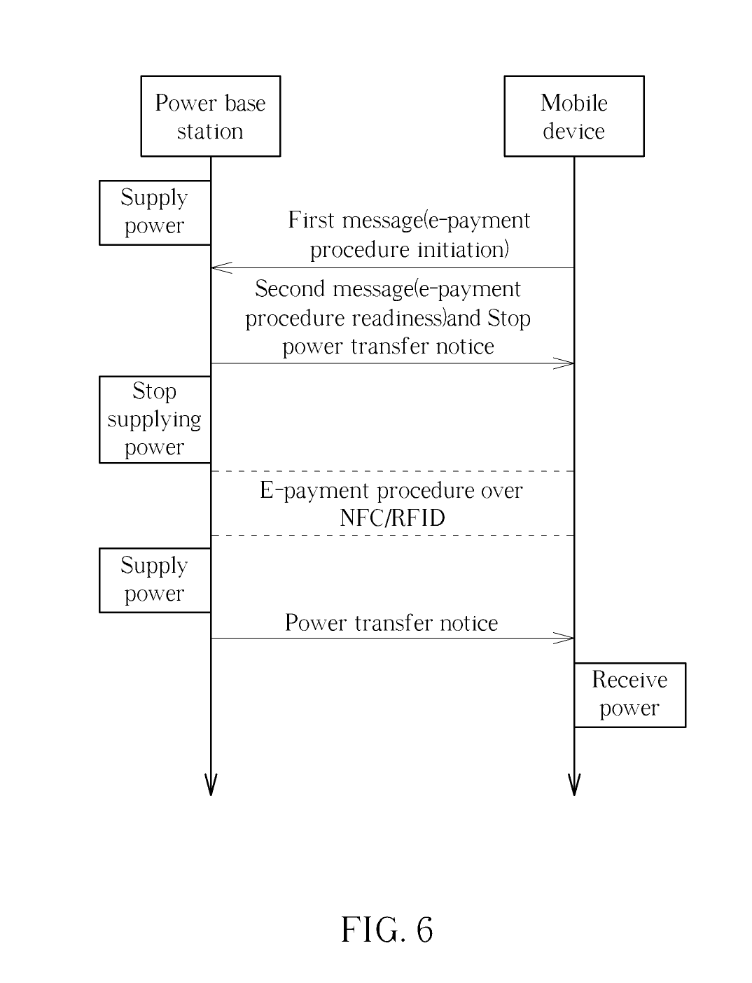

In another example, the e-payment procedure may be realized over communication technologies which generates interference to the wireless power or which suffers from interference of the wireless power, e.g. out-of-band communication such as NFC or RFID. In such a situation, the second message sent by the power base station may include a stop power transfer notice to notify that the wireless power will be stopped temporarily. Then, the power base station may stop wireless power transfer to switch to NFC or RFID communication technology in order to perform the e-payment procedure. At the end of the e-payment procedure, the power base station may supply wireless power again so that the mobile device may receive wireless power to make use of the wireless charging service. Specifically, the power base station may send a power transfer notice to the mobile device to notify that the power base station will restart the wireless power after the e-payment procedure is succeeded and/or ended, turn off the NFC or RFID communication, and resupply the wireless power. After a payment term of the e-payment procedure is due, the mobile device may perform the process 40 again to initiate a new e-payment procedure if the wireless charging service is still required. The signal diagram of this example is shown in FIG. 6.

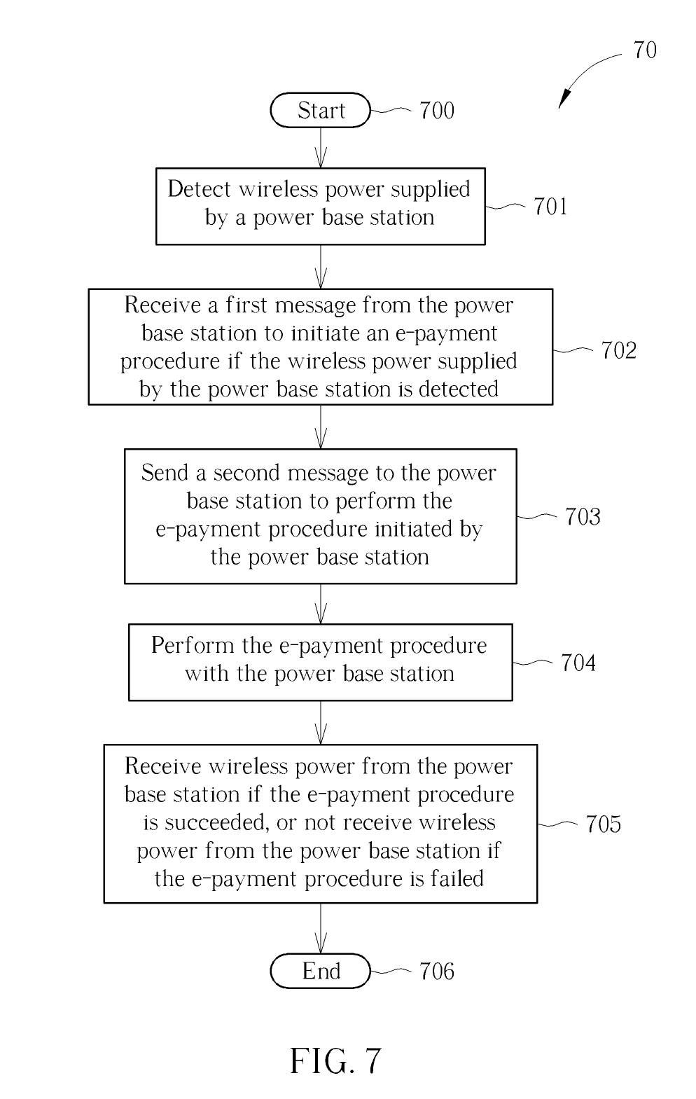

The above describes the examples where the e-payment procedure is initiated by the mobile device. In some cases, the e-payment procedure may be initiated by the power base station. Please refer to FIG. 7, which is a flowchart of a process 70 according to an example of the present invention. The process 70 may be utilized for a mobile device, such as the mobile device MD1, MD2-1 or MD2-2 shown in FIG. 3, to realize payment for the wireless charging service in a wireless charging system. A power base station may supply wireless power such that the mobile device is able to detect the wireless power to know it is close to the power base station with a power transmitter. After the mobile device discovers the power base station, the mobile device may start the process 70 which includes the following steps:

Step 700: Start.

Step 701: Detect wireless power supplied by a power base station.

Step 702: Receive a first message from the power base station to initiate an e-payment procedure if the wireless power supplied by the power base station is detected.

Step 703: Send a second message to the power base station to perform the e-payment procedure initiated by the power base station.

Step 704: Perform the e-payment procedure with the power base station.

Step 705: Receive wireless power from the power base station if the e-payment procedure is succeeded, or not receive wireless power from the power base station if the e-payment procedure is failed.

Step 706: End.

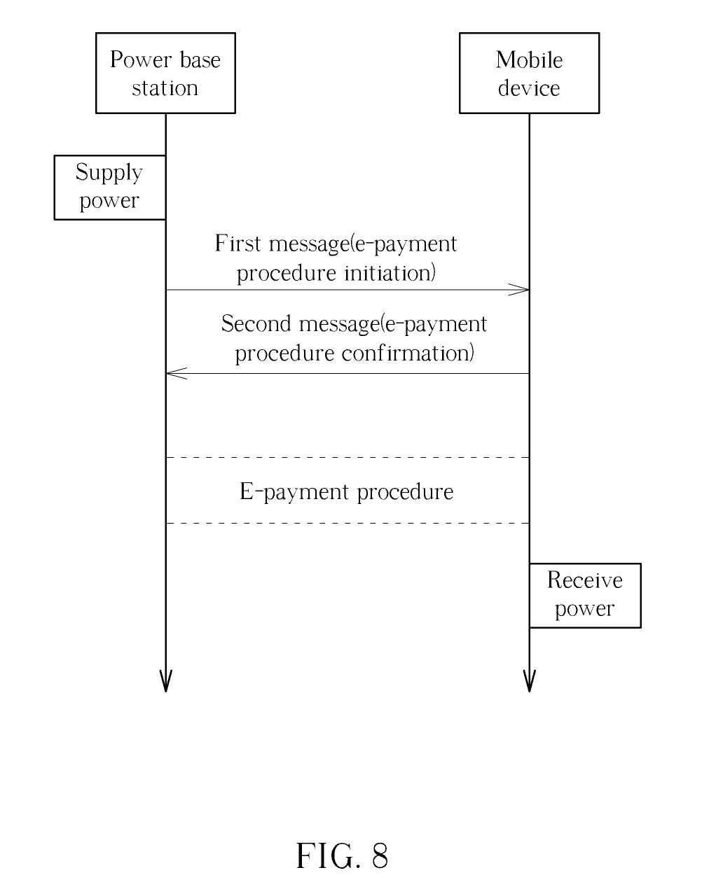

According to the process 70, the mobile device is configured to detect wireless power supplied by a power base station, receive the first message from the power base station to initiate an e-payment procedure if the wireless power supplied by the power base station is detected, transmit the second message to the power base station in order to perform the e-payment procedure initiated by the power base station, perform the e-payment procedure with the power base station, and determine whether to receive wireless power from the power base station according to the success or failure of the e-payment procedure. The first and second messages may be sent via bi-directional in-band communication channel. If the e-payment procedure is succeeded, the power base station may supply wireless power to the mobile device. On the contrary, if the e-payment procedure is failed, the power base station may avoid supplying wireless power or release a warning signal. In this manner, the wireless power provider may bill their customers via the e-payment procedure to meet the business requirement of deploying wireless charging services in public areas. The signal diagram of this example is shown in FIG. 8.

In an example, when the mobile device discovers the power base station, before the first and second messages are received and sent, the mobile device may send a third message to the power base station to notify that the e-payment procedure is supported or configured by the mobile device. Then, the power base station may send a fourth message to the mobile device to indicate payment rule(s) which contains the payment rule(s) of the e-payment procedure. Further, the payment rule may indicate a timing when the e-payment procedure shall be executed, a duration that the e-payment procedure is required, a period of the e-payment procedure, or a timing that the period starts. With the payment rule(s), an owner of the mobile device may decide to pay for the wireless charging service and the mobile device may start the process 70 once the owner agrees with the payment rule(s). This example is applicable to a wireless charging system where there is a communication channel from the power base station to the mobile device.

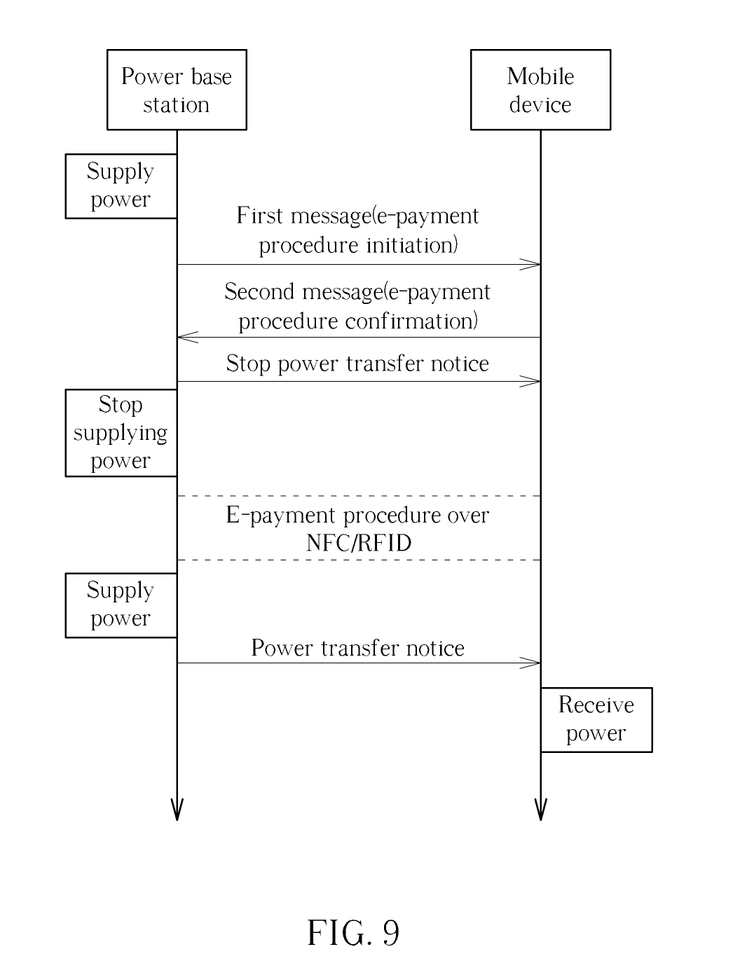

In another example, the e-payment procedure may be realized over communication technologies which generates interference to the wireless power or which suffers from interference of the wireless power, e.g. Near Field Communication (NFC) or Radio-Frequency Identification (RFID). In such a situation, the power base station may send a stop power transfer notice to notify that the wireless power will be stopped temporarily. Then, the power base station may stop wireless power transfer to switch to NFC or RFID communication technology in order to perform the e-payment procedure. At the end of the e-payment procedure, the power base station may supply wireless power again so that the mobile device may receive wireless power to make use of the wireless charging service. Specifically, the power base station may send a power transfer notice to the mobile device to notify that the power base station will restart the wireless power after the e-payment procedure is succeeded and/or ended, turn off the NFC or RFID communication, and resupply the wireless power. After a payment term of the e-payment procedure is due, the mobile device may perform the process 70 again to initiate a new e-payment procedure if the wireless charging service is still required. The signal diagram of this example is shown in FIG. 9.

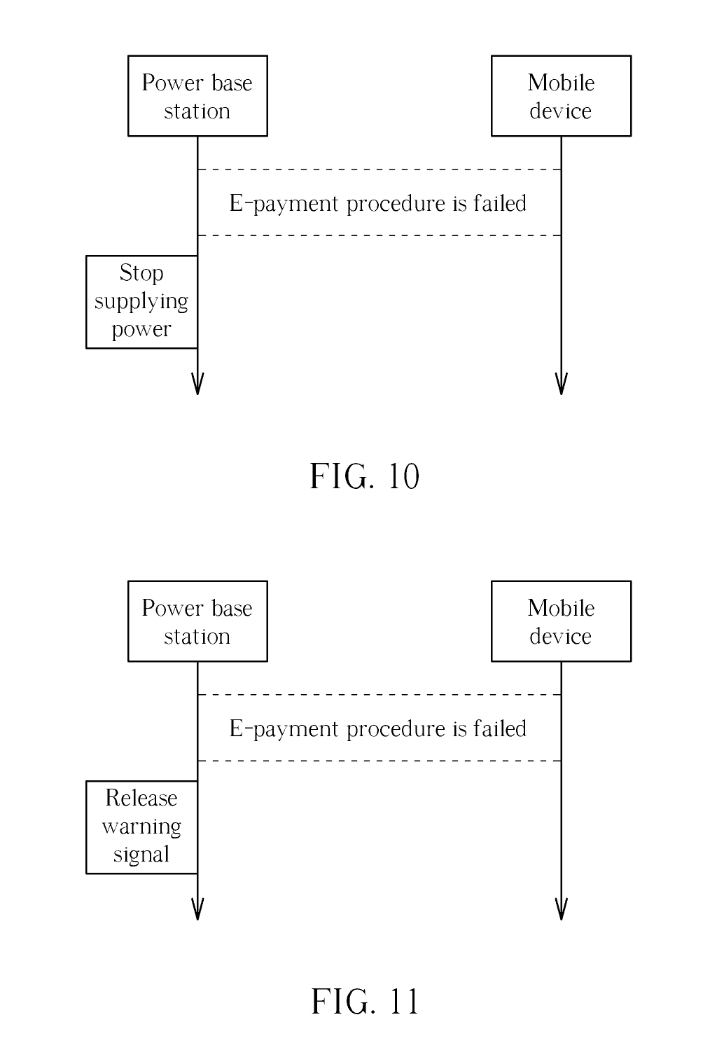

On the other hand, if the e-payment procedure is failed, the power base station may avoid supplying wireless power for a situation that the power base station only charges the mobile device. The signal diagram of this example is shown in FIG. 10.

Referring to the example shown in FIG. 11, if the e-payment procedure is failed, the power base station may release a warning signal which can bring immediate attentions of the surrounding people. The warning signal released by the power base station may be in the form of voice, speech, audio, image and/or video.

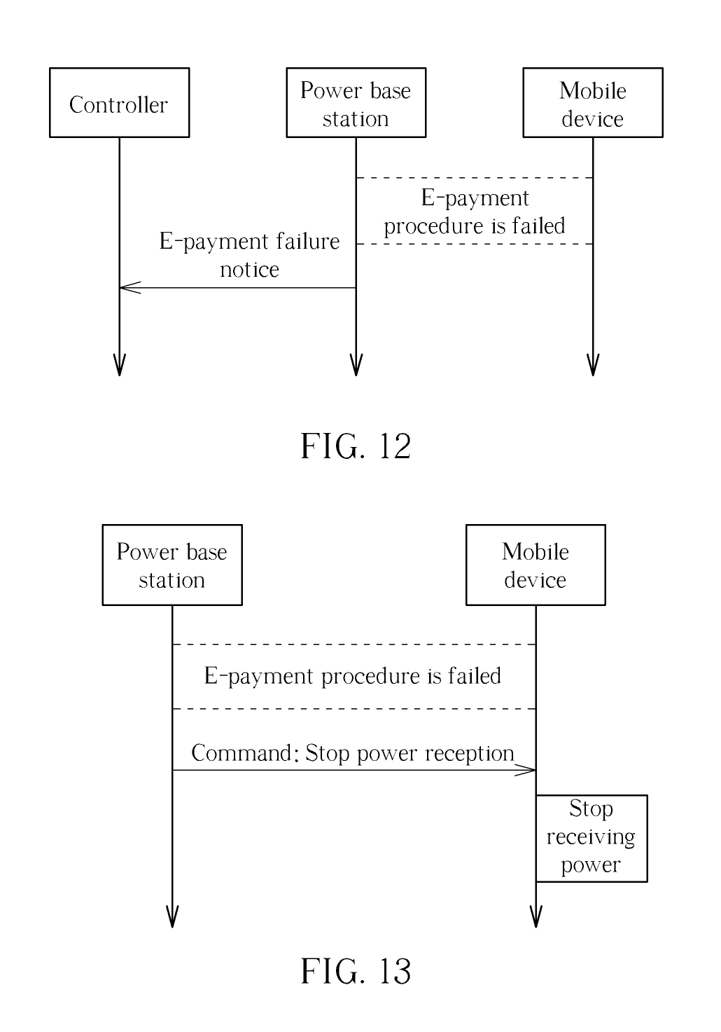

Referring to the example shown in FIG. 12, the power base station may send an e-payment failure notice to a controller (e.g. controller 300 shown in FIG. 3) if the e-payment procedure fails. The e-payment failure message informs the controller that the e-payment procedure for the mobile device fails. The e-payment failure notice may comprise at least one of the following: an identity of the mobile device, an identity of the power base station, a location of the power base station or the mobile device, and the reason of e-payment failure. Thus, people who monitor the controller can diagnose the failure issue based on the e-payment failure message and provide assistance if needed.

Referring to the example shown in FIG. 13, if the e-payment fails, the power base station may send a command (e.g. a stop power reception command) to the mobile device which requests the mobile device to stop receiving wireless power from the power base station. When the mobile device receives the command, it should stop receiving the wireless power. In practice, there may be multiple mobile devices using the wireless charging services on a same power base station, i.e. one power base station may charge multiple mobile devices at the same time. In such a situation, it is preferably to ask the mobile device on which the e-payment procedure is failed to stop receiving the wireless power, which ensures the wireless charging services are functional for other mobile devices on which the e-payment procedures are succeeded.

The abovementioned steps of the processes 40 and 70 including suggested steps may be realized by means of hardware, software, firmware, or an electronic system. Examples of hardware may include analog, digital and mixed circuits known as microcircuit, microchip, or silicon chip. Examples of the electronic system may include a system on chip (SOC), system in package (SiP), and a computer on module (COM).

To sum up, the present invention provides a method and related power base station and wireless charging system for payment for wireless charging. The wireless power provider may bill their customers via the e-payment procedure to meet the business requirement of deploying wireless charging services in public areas.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of payment for wireless charging service for a mobile device, comprising:
detecting wireless power supplied by a power base station;
sending a first message to the power base station to initiate an electronic payment (e-payment) procedure if the wireless power supplied by the power base station is detected;
receiving a second message from the power base station to indicate that the power base station is ready for the e-payment procedure;
performing the e-payment procedure with the power base station; and
receiving the wireless power from the power base station if the e-payment procedure is succeeded, or not receiving the wireless power from the power base station if the e-payment procedure is failed.

2. The method of claim 1, further comprising:
sending a third message to the power base station to query whether the e-payment procedure is required by the power base station and/or to indicate that the e-payment procedure is supported or configured by the mobile device; and
receiving a fourth message from the power base station which contains payment rule(s) of the e-payment procedure.

3. The method of claim 2, wherein the payment rule(s) indicates at least one of a timing when the e-payment procedure is executed, a duration that the e-payment procedure is required, and a period of the e-payment procedure or a timing that the period starts.

4. The method of claim 1, wherein the e-payment procedure is realized over a communication technology which generates interference to the wireless power or which suffers from interference of the wireless power.

5. The method of claim 4, wherein the second message sent by the power base station comprises a stop power transfer notice.

6. The method of claim 5, further comprising:
receiving a power transfer notice from the power base station to receive the wireless power after the e-payment procedure is succeeded and/or ended.

7. The method of claim 4, wherein the communication technology is Near Field Communication (NFC) or Radio-Frequency Identification (RFID).

8. The method of claim 1, wherein the first message sent by the mobile device and the second message sent by the power base station comprise at least one of an identity of the mobile device, information based on which an amount of money to be charged can be calculated, a timing that the e-payment procedure will start, a duration that the e-payment procedure will last, a period of the e-payment procedure if the e-payment procedure is made periodically, an amount of energy that the mobile device received from the beginning of charge or within a specific time period, a timing when the e-payment procedure is executed, a duration that the e-payment procedure is required, a period of the e-payment procedure or a timing that the period starts, and parameters for building up an e-payment connection.

9. The method of claim 1, further comprising:
receiving a command from the power base station to stop receiving wireless power from the power base station if the e-payment procedure is failed.

10. A method of payment for wireless charging service for a mobile device, comprising:
detecting wireless power supplied by a power base station;
receiving a first message from the power base station to initiate an electronic payment (e-payment) procedure if the wireless power supplied by the power base station is detected;
sending a second message to the power base station to perform the e-payment procedure initiated by the power base station;
performing the e-payment procedure with the power base station; and
receiving wireless power from the power base station if the e-payment procedure is succeeded, or not receiving the wireless power from the power base station if the e-payment procedure is failed.

11. The method of claim 10, further comprising:
sending a third message to the power base station to notify that the mobile device supports the e-payment procedure; and
receiving a fourth message from the power base station which contains payment rule(s) of the e-payment procedure.

12. The method of claim 10, wherein the payment rule(s) indicates at least one of a timing when the e-payment procedure is executed, a duration that the e-payment procedure is required, and a period of the e-payment procedure or a timing that the period starts.

13. The method of claim 10, wherein the e-payment procedure is realized over a communication technology which generates interference to the wireless power or which suffers from interference of the wireless power.

14. The method of claim 13, further comprising:
receiving a stop power transfer notice to stop receiving the wireless power and perform the e-payment procedure initiated by the power base station.

15. The method of claim 14, further comprising:
receiving a power transfer notice from the power base station to receive the wireless power after the e-payment procedure is succeeded and/or ended.

16. The method of claim 13, wherein the communication technology is Near Field Communication (NFC) or Radio-Frequency Identification (RFID).

17. The method of claim 10, wherein the first message sent by the power base station and the second message sent by the mobile device comprise at least one of an identity of the mobile device, information based on which an amount of money to be charged can be calculated, a timing that the e-payment procedure will start, a duration that the e-payment procedure will last, a period of the e-payment procedure if the e-payment procedure is made periodically, an amount of energy that the mobile device received from the beginning of charge or within a specific time period, a timing when the e-payment procedure is executed, a duration that the e-payment procedure is required, a period of the e-payment procedure or a timing that the period starts, and parameters for building up an e-payment connection.

18. The method of claim 10, further comprising:
receiving a command from the power base station to stop receiving wireless power from the power base station if the e-payment procedure is failed.
